(19) United States
(12) Patent Application Publication
(10) Pub. No.: US 2002/0156709 A1
(43) Pub. Date: Oct. 24, 2002

(54) Debt financing for companies

(75) Inventors: David Andrus, Boulder, CO (US); Stephen David Jones, Bayswater (GB)

Correspondence Address: SHEARMAN & STERLING, INTELLECTUAL PROPERTY DOCKETING, 599 LEXINGTON AVENUE, NEW YORK, NY, 10022, US

(73) Assignee: Pearl Street Financial Group Ltd.

(21) Appl. No.: 10/046,418

(22) Filed: Oct. 29, 2001

Related U.S. Application Data
(60) Provisional application No. 60/243,981, filed on Oct. 27, 2000.

(51) Int. Cl. G06F 17/60

(52) U.S. Cl. 705/35

(57) ABSTRACT

An investment company receives funds from a plurality of unaffiliated capital markets investors. The investors receiving in return a debt claim against the investment company. The investment company invests a substantial majority of the invested funds from the investment company directly into operating companies as debt obligations of the operating companies for essentially unrestricted use by the operating companies, the terms providing at least one year of relief from repayment of the debt. The investment company receives a security interest in substantially all assets of the operating companies. Out of the invested funds, the investment company purchases an insurance policy for the benefit of the investors. The insurance policy covers the investment company against default by the operating companies and insures repayment to the investor of the funds invested. The insurer of the insurance policy receives benefit of debt and equity interests in the operating companies.

### CROSS REFERENCE TO RELATED APPLICATION

This application claims the benefit of U.S. Provisional Application Serial No. 60/243,981, filed Oct. 27, 2000, which is incorporated herein by reference.

### BACKGROUND

The invention relates to financial or business practices.

Start-up companies that rely on venture capital funding to develop their businesses normally obtain financing through successive “rounds” of financing, to bring the company to maturity. “Seed round” or “first round” financing allows a company to take an idea from conception to a first prototype, to demonstrate technical viability, and to get to a product development stage. Seed round financing could come from venture capital (VC) funds that specialize in seed round or first round companies, from “business angels,” or from the owners themselves.

“Second round” and “third round” financing generally takes a product from technical viability into a fully-fledged market product. Typical second round financings range from $ 5 million to $ 20 million. Typical third round financings range from $ 20 to $ 50 million. At second and third rounds, the company sells between 25%-50% of the equity, typically as preferred stock. There may be fourth or fifth rounds of financing, depending on the company's expansion needs. In later rounds, the valuation of the company is typically progressively higher, and the dilution progressively less.

In a typical “mezzanine round” financing, typically the last round before an initial public offering (IPO), the company may issue debt and warrants (warrants are options exercisable for a given number of shares in the company at a given price).

The capital markets are generally understood to include investors who invest through public offerings or secondary market exchanges, investors through private placements, angel investors, and other forms of financing arranged through arms-length transactions. The term “capital markets” is generally understood to exclude financing arranged among affiliated companies and bank deposits.

As a company becomes more established, it may be able to borrow, by pledging assets or by demonstrating that it has sufficient cash flow to service the debt.

VC's sometimes receive hybrid debt-equity securities, equity shares that repay the investment through a fixed coupon yield.

To go public (or to sell to an acquirer), a company typically has to demonstrate that it can manufacture its product and that it has a functioning distribution chain, and is (or will be) profitable.

At each round of VC financing there is typically a lead VC who studies the company and sets the valuation. Typically, the existing investors are expected to increase their investment, and the VC syndicates his own round out among co-investors. At each round, the negotiations between existing investors and the new VC center on the amount of equity that the VC will receive for his investment. The existing investors want to reduce “equity dilution,” that is, they want to reduce the number of equity shares among which future earnings are to be distributed, and to increase or maintain voting control. The VC wants to obtain as much equity as possible for the investment. These determinations, in turn, depend on the valuation for the company as of the date of the investment.

A VC's ability to attract investment to fund his deals depends on two things: (a) his performance on past deals, typically measured by Internal Rate of Return (IRR), and (b) his ability to distribute cash to his co-investors at the end of predetermined time, typically five to ten years. A typical subscription agreement between a VC and a company states the VC's “exit,” the point at which the VC is repaid with a return, so that the VC can deliver investment returns to his co-investors. Therefore, the VC typically requests that the company commit to an IPO, or a sale or merger, or some form of liquidation, at a predetermined time, so that the VC in turn may be able to deliver a return or make a distribution to his co-investors.

### SUMMARY

In general, in a first aspect, the invention features a method. An investment company receives funds from a capital markets investor. The investment company invests a substantial majority of the invested funds from the investment company into one or more operating companies. The investment company arranges an insurance policy for the benefit of the investor, the insurance policy insuring repayment to the investor of the funds invested, the insurer of the insurance policy receiving benefit of debt and equity interests in the operating company or companies.

In general, in a second aspect, the invention features a method. An investment company receives funds from a capital markets investor. The investment company invests a substantial majority of the invested funds into an operating company as a debt obligation of the operating company, the terms providing at least one year of relief from repayment of the debt.

In general, in a third aspect, the invention features a method. An investment company receives funds from a plurality of capital markets investors. The investment company invests a substantial majority of the invested finds from the investment company directly to an operating company for business expansion of the operating company. The investment company receives a security interest in substantially all assets of the operating company. Out of the invested funds, the investment company purchases an insurance policy covering the investment company against default by the operating company and insuring repayment of principal to the investors.

In general, in a fourth aspect, the invention features a method. An investment company receives funds from a plurality of unaffiliated capital markets investors. The investment company invests a substantial majority of the invested funds out to one or more operating companies for essentially unrestricted use by the operating companies. The investment company receives a security interest in substantially all assets of the operating companies.

In general, in a fifth aspect, the invention features method. An investment company receives funds from capital markets investors. The investors receive in return a debt claim against the investment company. The debt claim is covered by an insurance policy insuring payment of principal and interest. The investment company invests a substantial majority of the invested funds out to one or more operating companies.

Preferred embodiments of the invention may include one or more of the following features. The debt claim received by the investor may be an indirect claim, co-mingled with debt claims against other operating companies. The insurance policy may insure payment of principal and interest arising under the debt claim. The investor may receive no equity in the investment company. An agreement between the investor and the investment company may contemplate repayment of the funds within seven years. The investment company may receive an equity interest in the operating company in return for its investment. The equity interest received by the investment company may include a warrant exercisable for stock of the operating company. The investment company may receive a debt interest in the operating company in return for its investment. The debt issued by the operating company may provide for repayment forbearance for at least one year. The operating company may receive unrestricted use of funds invested by the investment company. The investment company may include a number of separate entities chartered in several distinct jurisdictions. The investment company may include a special purpose vehicle chartered to hold the assets and liabilities of a single series of funds received from capital markets investors.

The above advantages and features are of representative embodiments only, and are presented only to assist in understanding the invention. It should be understood that they are not to be considered limitations on the invention as defined by the claims, or limitations on equivalents to the claims. Additional features and advantages of the invention will become apparent in the following description, from the drawings, and from the claims.

### DESCRIPTION OF THE DRAWING

FIGS. 1a, 1b and 2 are block diagrams of a financial arrangement.

FIG. 3 is a timeline of responsibilities for steps shown in FIG. 2.

FIGS. 4 and 5 are timelines of cash flows.

### DESCRIPTION

I. Overview

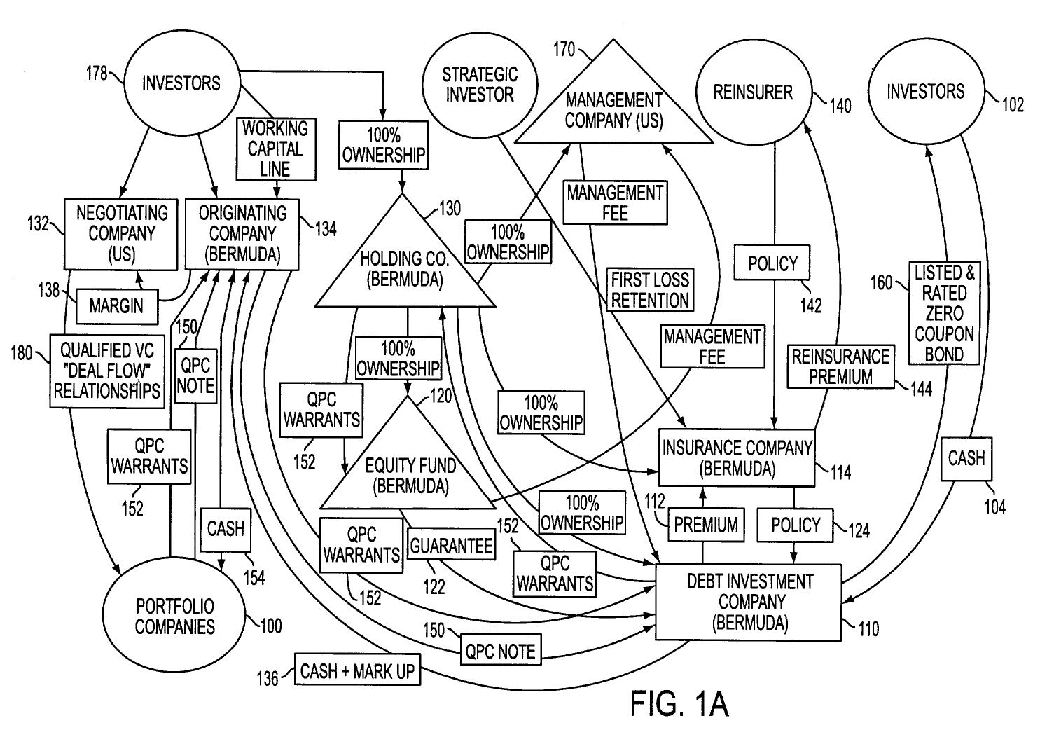

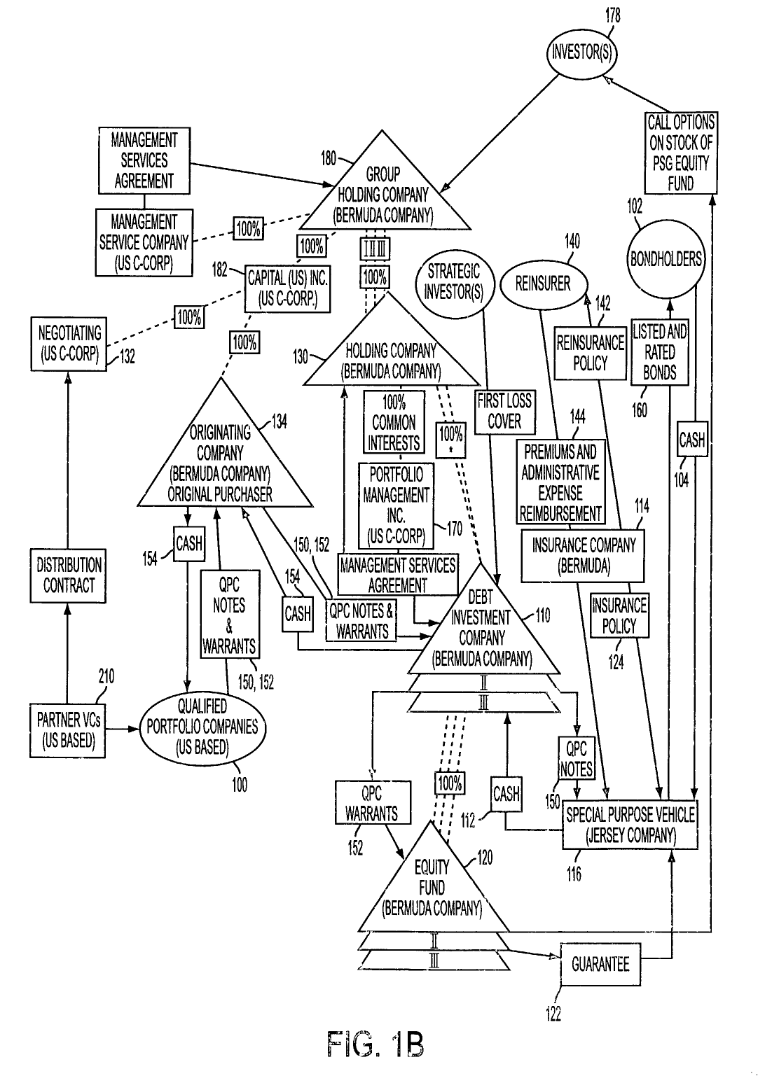

Referring to FIGS. 1a and 1b, a financing arrangement is made between an operating company 100, a Bondholder 102, and an Insurance Company 114. Bondholder 102 invests money 104 in operating company 100, and may, for instance, receive a note or bond payable in three to five years. Insurance Company 114 insures payment of principal and interest to the Bondholder 102 when the note or bond comes due. Operating company 100 may also give Insurance Company 114 (and therefore, indirectly, Bondholder 102) an equity interest in the operating company 100 based on a percentage of the amount of the note or bond. For instance, operating company 100 may issue QPC Warrants 152 for the operating company's stock, and give Insurance Company 114 a right to recover against exercise of QPC Warrants 152.

Several of these deals may be formed in parallel and the risks pooled, to reduce the default risk on the portfolio of bonds and enhance insurability. For instance, a Debt Investment Company 110 may be established to invest money in companies 100 on QPC Notes 150, to acquire securities 152, 150 from several companies 100, and to issue Bonds 160 to the Bondholder 102 that aggregate the payment streams on the underlying QPC Notes 150 (rather than Bondholder 102 investing in and receiving a bond directly from a single operating company 100). Repayment of QPC Notes 150 by operating companies 100 is used to repay Bonds 160. Insurance Company 114 may insure payment on Bonds 160 issued by Debt Investment Company 110. Debt Investment Company 110 may hold QPC Warrants 152 and give Insurance Company 114 a claim against the portfolio of QPC Warrants 152 in the event of default or shortfall on QPC Notes 150.

Debt financing for the operating company 100 may be beneficial to the owners of operating company 100 (including any VC): rather than syndicating a deal out to associates, and diluting equity, the owners can raise capital through debt financing. By raising debt instead of selling equity, the VC's may reduce dilution of their equity stakes in operating companies 100, increase their IRR's, and increase the cash return to their investors. These improvements may feed the VC's ability to raise money for the next deal, and increase visibility as a market leader. Conversely, VC's may be disinclined to seek debt financing for operating companies that are not likely to succeed because, if these companies default on their QPC Notes 150, Debt Investment Company 110 and/or Insurance Company 114 may have priority over the VC's equity interest in the assets of operating company 100 and the VC will have subordinated its right to recoup its investment. Founders, managers and other equity holders of operating company 100 may also benefit from debt financing, because of reduced equity dilution and the improved valuation of share options.

II. Parties

A. First Alternative Structure

Debt Investment Company 110 (or one or more other parties, possibly including one or more of Insurance Company 114, Negotiating Company 132, or Originating Company 134) may be responsible for careful evaluation of companies 100 that will qualify for debt investment under the arrangement of FIGS. 1a and 1b. Companies 100 that meet the conditions of this evaluation may be called “Qualifying Portfolio Companies.” Those qualifying conditions may include a minimum equity cover, minimum asset cover (as adjusted), projected cash cover, and a proven business model evidenced, e.g., by the shipment of product to customers paying list price, having the VC partner investing in the same round as the debt financing arrangement, having that VC partner having done the relevant due diligence, and/or having reports that confirm that the qualifying conditions have been satisfied and would be satisfied by operating company 100. Debt Investment Company 100's investment guidelines may require portfolio companies 100 to have projected cash flow from operations for the year prior to maturity of note 150 equal to at least 200% of the accreted principal amount of note 150 at maturity.

As part of qualifying operating companies 100 for debt financing, Insurance Company 114 (or other parties) may consider the VC firm that has funded operating company 100. Generally, Debt Investment Company 110 will maintain relationships (either directly or indirectly) with top-performing VC firms (both in terms of IRR and portfolio company failure rates), and these firms will be providing the deal flow 220 of companies 100 in which Debt Investment Company 110 will invest. Debt Investment Company 110 may seek to deal with two principal classes of VC firms: historic performers and strategic partners. A historic performer VC firm may be one whose funds have achieved an IRR as reported in the most recently available Venture Economics in the top 25% of venture capital firms for the applicable vintage year, the year of fund formation and first takedown of capital and (b) has particular experience in its targeted investment sectors. A strategic partner VC may be selected by discretionary review to add to the overall strategic investment scheme. A strategic partner VC may meet certain criteria, including: (a) having substantial experience in the targeted investment sector; (b) a projected IRR that equals or exceeds certain financial assumptions, and (c) has operating companies 100 in its portfolio that add balanced risk to the portfolio as a whole. Debt Investment Company 110 may also have a small discretionary part of the budget that can be used for companies that are not sponsored by either a historic performer or market leader VC, but whose business plan seems exceptionally good.

Efficiency of the arrangement may be improved if the companies 100 are relatively similar to each other, so that the parties 102, 114, 110 may develop expertise in evaluating the companies 100 and the accompanying risk. For instance, the parties 102, 114, 110 to the arrangement may focus on companies 100 in related fields, at any of several scopes: for example, technology companies, internet companies, internet service companies, internet infrastructure companies, etc software, semiconductor, communication, energy, bio-technology, retail, etc. The arrangement may focus on companies between product viability stage and product development and marketing stage. For instance, the arrangement may be targeted to companies that have a proven prototype of the product. In addition, it may have developed or started to develop its customer base, it may have paying customers, and/or it may be shipping product to those customers. Operating company 100 may be seeking funding for continued research and product development, initial marketing, manufacturing and sales activities, or expanding production, shipping and sales volume. In the VC industry, these companies are typically working with second or third round financing, and are called “early mid-stage” or “expansion stage.” Risk may be reduced by selecting a portfolio of companies that are relatively diverse from each other. For example, a portfolio may include companies in software, semiconductors, telecommunications, energy, biotechnology, retail, etc.

Bondholders 102 may invest money 104 with Debt Investment Company 110. The arrangement may contractually guarantee that Bondholders 102 receive a return of the invested principal and an insured rate of return.

Debt Investment Company 110 may be established as a Bermuda segregated accounts company, or a bankruptcy-remote entity, typically in a tax-haven jurisdiction such as Jersey or the Cayman Islands. The “segregated accounts company” status allows Debt Investment Company 110 to organize several distinct portfolios of securities, for instance at different times and using investments from different investors, that have no cross-liability, and are bankruptcy-remote from each other and from the accounts of Debt Investment Company 110 itself. Bond proceeds 104 are credited to segregated accounts within Debt Investment Company 110, and QPC Notes 150 are similarly credited to the segregated account.

In another alternative, a new bankruptcy-remote special purpose vehicle may be established for each fund, with bond proceeds 104, QPC Notes 150 and QPC Warrants 152 flowing in, and cash 136 lent out and Bonds 160 flowing out at fund origination. Each special purpose vehicle is owned by Debt Investment Company 110.

Debt Investment Company 110 invests the funds 104 received from Bondholders 102 in the portfolio companies 100. In return, companies 100 issue QPC Notes 150 and QPC Warrants 152 to Debt Investment Company 110. By consolidating debt assets and/or equity assets (QPC Notes 150 and QPC Warrants 152) from a number of companies, Debt Investment Company 110 may reduce the risk of the aggregate portfolio so that Insurance Company 114 and reinsurers 140 may be made comfortable in writing the risk.

Debt Investment Company 110 may hold QPC Notes 150 and QPC Warrants 152 on it own books. Alternatively, Debt Investment Company 110 may transfer one or the other to Equity Fund 120. In one alternative, Equity Fund 120 may be a company limited by shares and organized under Bermuda law. Debt Investment Company 110 may hold QPC Notes 150 on its own books, and transfer QPC Warrants 152 to Equity Fund 120. Equity Fund 120 may provide cover to increase likelihood of the payment obligation 160 of Debt Investment Company 110.

Insurance Company 114 may be a Bermuda corporation that will be treated as a corporation and a “passive foreign investment company” for U.S. tax purposes. Insurance Company 114 may be licensed as a Class 1 or Class 3 insurer (or other class) under Bermuda law and may issue a separate insurance policy 124 insuring repayment of each series of Bonds 160.

Each Bond offering 160 may give rise to a different series of ownership interests in Insurance Company 114. Debt Investment Company 110 may pay an insurance premium 112 to Insurance Company 114 to cover the risk of the portfolio of Bonds 160 issued by Debt Investment Company 110. The amount of insurance premium 112 may be negotiated between Debt Investment Company 110 and Insurance Company 114; for example, premium 112 may be about 2% per year of the value of the Bond portfolio. In return for premium 112, Insurance Company 114 issues a bond insurance policy 124 in favor of Debt Investment Company 110 or bond holders 102. Policy 124 is placed in the appropriate segregated account of Debt Investment Company 110, in the name of a trustee for the benefit of Debt Investment Company 110 or bond holders 102. Insurance Company 114 may reinsure its risks under policy 124 with reinsurers 140; in one alternative, Insurance Company 114 may lay off 90% of the risk.

Insurance Company 114 may bring in a strategic third party investor, typically an institutional investor (e.g., holding company 130), to provide it with the balance of the cover required, e.g., the 10% it writes for its own book. Capital received from the investor may be held in its general account to secure that risk. This investment may be in the form of a capital commitment or guarantee, and may be held as part of the Insurance Company's assets to satisfy regulatory requirements. In some embodiments without an Insurance Company, the capital investment is forwarded directly to Debt Investment Company 110.

Equity Fund 120 may provide risk cover to Insurance Company 114. In return for a fee (essentially a reinsurance premium) from Debt Investment Company 110, Equity Fund 120 gives a Guarantee 122, backed by those assets, to Debt Investment Company 110 and/or Insurance Company 114, which, in turn, directly or indirectly pledges 124 its interest in QPC Warrants 152 to reinsurers 140. When Bonds 160 mature and Bondholders 102 must be paid, any shortfall in the capital available to repay Bonds 160 will be insured 124 by Insurance Company 114 and reinsurers 140. In turn, Insurance Company 114 and reinsurers 140 may recover any losses from Equity Fund 120.

Holding company 130 may be a Bermuda corporation that will “check the box” to be treated as a disregarded entity for U.S. tax purposes.

In one embodiment, Debt Investment Company 110, Insurance Company 114, and Equity Fund 120 may all be wholly-owned (directly or indirectly owned) subsidiaries of holding company 130. For example, holding company 130 may wholly own Insurance Company 114, which may wholly own Debt Investment Company 110, which may wholly own Equity Fund 120. Any combination of ownership of holding company 130 may be employed. Holding company 130 may be organized as a Bermuda Limited Liability Company or other limited liability form. Debt Investment Company 110, Insurance Company 114, Equity Fund 120, and holding company 130 may alternatively be organized as bankruptcy-remote entities under the laws of other tax-haven jurisdictions.

QPC Warrants 152 may have an expiration date of ten years from issue, another amount of time, or may have no expiration date.

In alternative embodiments, the “equity kicker” provided by QPC Warrants 152 may be provided by other equity securities to be held in Equity Fund 120. For instance, the equity securities 152 could be common shares, preferred shares, preference shares, convertible preferred shares, convertible notes, or other convertible securities, or other equity-linked derivative securities. The maturity or expiration dates of such securities may vary.

It may be desirable to separate the functions of negotiating deals in the United States from the function of originating securities for United States issuers. U.S. Negotiating Company 132 may negotiate and structure deals with companies 100 and VC's, while the securities may be originated by Originating Company 134. Originating Company 134 acts as an independent U.S. originator of QPC Warrants 152 and QPC Notes 150. In some embodiments the entities involved may be distinct yet have a cooperative relationship where Originating Company 134 does not purchase QPC Notes 150 and QPC Warrants 152 as principal. Debt Investment Company 110 may purchase securities from Originating Company 134 (Debt Investment Company 110 may purchase from originators other than Originating Company 134 as well); out of the proceeds 136 paid by Debt Investment Company 110 to Originating Company 134, Originating Company 134 may pay a margin 138 to Negotiating Company 132. Negotiating Company 132 may be a Delaware corporation or limited liability company, and Originating Company 134 may be a Bermuda limited company or corporation. Both Negotiating Company 132 and Originating Company 134 may be owned by a Delaware corporation.

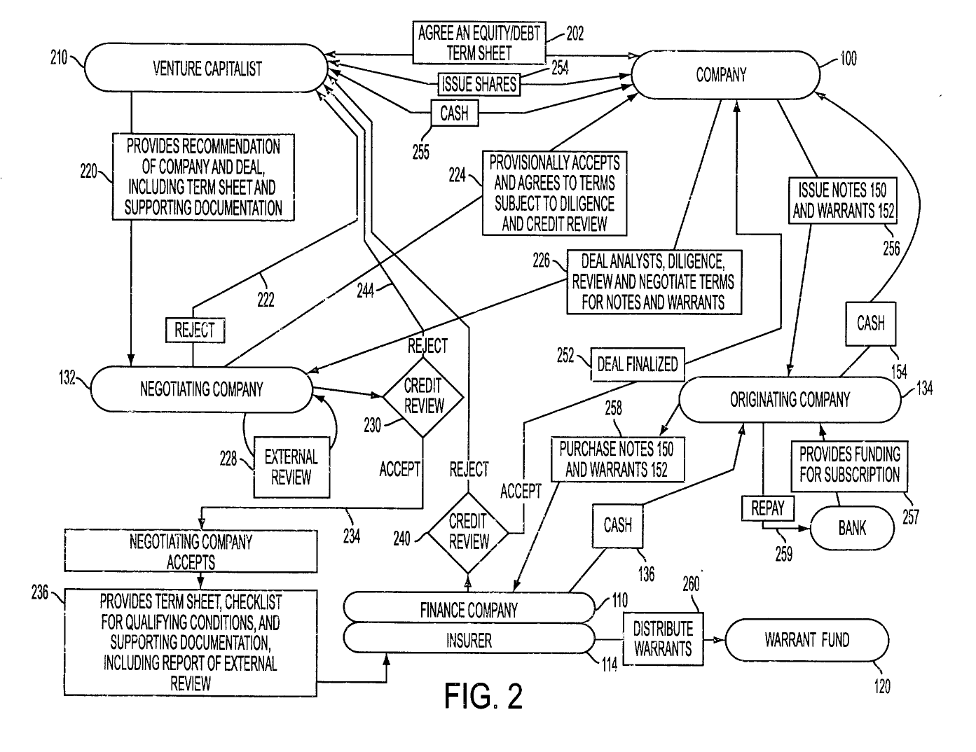

For deals not involving United States law, Negotiating Company 132 and Originating Company 134 may be a single entity. (FIGS. 2-4 show a single entity referred to as “Originating Company 132, 134,” though it should be understood that the two functions may be split in some instances.) In some embodiments, depending on the facts of a particular deal and the regulatory regime in which each company 100, 110, 114, 132, 134 operates, functions may be performed by any two or more of Debt Investment Company 110, Insurance Company 114, Negotiating Company 132 and Originating Company 134. Alternatively functions may be performed by a combined single entity and Debt Investment Company 110 may actively negotiate and originate QPC Notes 150 and QPC Warrants 152.

Contractual relationships with Originating Company 134 may provide Debt Investment Company 110 with a right of first refusal to purchase securities from Originating Company 134 (with no obligation to purchase all or any portion of QPC Notes 150 offered by Originating Company 134). Alternatively, Originating Company 134 may be contractually barred from originating any securities that Debt Investment Company 110 does not purchase.

In some cases, Debt Investment Company 110 and Insurance Company 114 may rely on the due diligence already done by previous or contemporaneous investors. This may be attractive when the other VC's investing in operating company 100 have demonstrated a sound track record. Alternatively, Debt Investment Company 110 may conduct its own independent due diligence (separate and independent from Originating Company's or any other originator's due diligence) with independent reviews being commissioned by internationally recognized accountants and experts.

Reinsurer 140 may have a mitigation right three years (for example) after issuance of Bonds 160 to take any steps it deems commercially prudent in order to mitigate potential losses, if at that time specified performance criteria have not been satisfied by Debt Investment Company 110 and the performance of QPC Notes 150 and QPC Warrants 152.

Management company 170 may provide oversight and monitoring of portfolio companies 100 during the tenor of QPC Notes 150. Management company 170 may be a wholly-owned subsidiary of holding company 130. Management company may also serve as plaintiff in any debt collection action against companies 100. Management company 170 may also provide periodic reports to Insurance Company 114 and reinsurers 140, to provide reassurance of oversight and performance monitoring.

B. Second alternative structure

Investors 178 may invest cash in exchange for equity in Group Holding Company 180.

These Investors 178 may include Partner VCs. Additional rounds of investment at different valuations can be accommodated.

Group Holding Company 180 may be a Bermuda corporation that may “check the box” to be taxed as a partnership for U.S. tax purposes. Group Holding Company 180 may make periodic distributions of cash, have subsequent rounds of investment by outside investors at different valuations and conduct an IPO outside of the US, for example in the United Kingdom.

Group Holding Company 180 may invest cash and other property contributed by Investors 178 into Holding Company 130 in exchange for 100% ownership of Holding Company 130. There may be a separate series of equity ownership interests in Holding Company 130 for each successive issue of Bonds 160. Group Holding Company 180 may invest in other venture capital deals such as side-by-side funds, fund of funds, and other products.

Holding Company 130 may create a series of daughter Debt Investment Companies 110, Special Purpose Vehicles 116, and Equity Funds 120, one trio of companies 110, 116, 120 for each Bond offering 160.

Special Purpose Vehicle 116 may be organized as a special purpose, bankruptcy remote entity that is organized under the laws of Bermuda, the Cayman Islands, Jersey or a similar offshore jurisdiction that offers a favorable tax system. The common shares of Special Purpose Vehicle 116 may be owned by a trustee in trust for unrelated charitable organizations. Special Purpose Vehicle 116 may have independent directors who have no decision-making responsibility regarding the acquisition of QPC Notes 150 by Special Purpose Vehicle 116. In addition to Bonds 160, Insurance Company's capital structure may consist of the following (i) common shares to be issued to a trust for the benefit of a charity, (ii) preference shares to be issued to Debt Investment Company 110 and possibly to the provider(s) of the “first loss cover” (the “First Loss Cover Provider”) depending on how the first loss cover is structured.

Each Special Purpose Vehicle 116 may be a separate Bermuda corporation that may “check the box” to be treated as a disregarded entity for U.S. tax purposes. Each Special Purpose Vehicle 116 may be an issuer of Bonds 160. Successive sister Special Purpose Vehicle 116 may be created as wholly-owned subsidiaries of Holding Company 130 to issue subsequent series of Bonds 160 and to purchase QPC Notes 150 and QPC Warrants 152 with the proceeds of such Bond issues 160.

Debt Investment Company 110 may be organized as a Bermuda limited company to engage in various investment and other activities. Debt Investment Company 110 may make independent investment decisions, through its investment committee, as to whether or not to purchase QPC Notes 150 and related QPC Warrants 152 offered to it from time to time by Originating Company 132, 134, including the initial purchase, and may cause the Manager to conduct due diligence on its behalf relating to any QPC Notes 150 and QPC Warrants 152 that it proposes to purchase.

Each Debt Investment Company 110 may enter into a contractual arrangement with Originating Company 134 pursuant to which Originating Company 134 may grant the Debt Investment Company 110 a right of first refusal to purchase QPC Notes 150 and QPC Warrants 152 that Originating Company 132, 134 acquires through the investments it makes in Qualified Portfolio Companies. Each Debt Investment Company 110 may use the net cash proceeds from its Bond offering 160 to purchase QPC Notes 150 and QPC Warrants 152 from Originating Company 134. QPC Notes 150 may be held by the Debt Investment Company 110. QPC Warrants 152 may be assigned by the Debt Investment Company 110 to the related Equity Fund 120 as consideration for the Equity Fund's Guarantee 122 of Bonds 160.

Each Debt Investment Company 110 may have an independent committee of its Board that may make separate independent decisions regarding the investment of bond proceeds 104 in QPC Notes 150 and QPC Warrants 152 originated by Originating Company 132, 134 or other originators. A majority of the members of the Investment Committee may typically be independent, possibly including one representative of Investors 178 and/or of bondholders 102, the Manager and/or the provider of the first loss cover. The CEO of Group Holding Company 180 may generally be excluded from service on a Debt Investment Company's independent committee. The Investment Committee may have the exclusive authority to make its own independent review of the proposed purchase of QPC Notes 150 and QPC Warrants 152 and to accept or reject the offer.

Each Equity Fund 120 may be a bankruptcy remote, special purpose entity that is wholly owned by Debt Investment Company 110. Each Equity Fund 120 may be organized as a separate Bermuda corporation that may “check the box” to be treated as a disregarded entity for U.S. tax purposes. Each Equity Fund's primary investment purpose may be to own QPC Warrants 152 and to issue Guarantee 122.

Successive Equity Funds 120 may be created as wholly-owned subsidiaries of their related parent Debt Investment Companies 110 to hold QPC Warrants 152 attributable to the subsequent series of Bonds 160. Each Equity Fund 120 may separately guarantee the repayment of Bonds 160 issued by its parent Debt Investment Company 110, as well as other obligations of the Debt Investment Company 110, including payment of insurance premiums 112. Proceeds not required to be applied to payments on Guarantee 122 may be distributable to Debt Investment Company 110, and by Debt Investment Company 110 to its shareholder.

Originating Company 132, 134 may be organized as a Delaware corporation, possibly with affiliates, that is engaged in the business of investing in Qualified Portfolio Companies. Originating Company 132, 134 may have relationships with venture capital firms that satisfy specific criteria as to historic performance and market leadership or other strategic advantages. Contracts with the VC's may grant Originating Company 132, 134 the right of first refusal to provide investment to QPCs. The contracts may specify the criteria for qualified portfolio companies (“QPCs”), as well as the number of QPCs to be presented by the VCs to Originating Company 132, 134 for its consideration over a specified period of time. Pursuant to these relationships, the Partner VCs may introduce Originating Company 132, 134 to those portfolio companies 100 that satisfy the criteria of Qualified Portfolio Companies and are candidates for financing. Originating Company 132, 134 may typically have its own employees.

A Service Company 170 may have employees who manage Holding company 130 and its investments including Equity Funds 120, Special Purpose Vehicle 116 and its associated Debt Investment Companies 110 pursuant to a Management and Services Agreement among these four entities. Such management services may include conducting due diligence, monitoring the Qualified Portfolio Companies 100, making decisions regarding the liquidation of the collateral and performing certain administrative duties such as the collection of funds with respect to QPC Notes 150 and QPC Warrants 152 on behalf of Special Purpose Vehicle 116, Equity Fund 120 or Debt Investment Company 110, as applicable. There may be separate agreements for each successive Bond issue 160. Incentive Packages for Service Company's management and employees may be structured to include a Bond Fund bonus and Equity Fund bonus. The Bond Fund bonus may be payable only if (a) Bonds 160 have been paid in full, or sufficient cash has been set aside to pay Bonds 160 in full when due, and (b) the default rate on QPC Notes 150 in the Bond Fund is less than a projected default rate. The Bond Fund bonus may be a certain percentage of the excess funds in the Bond Fund resulting from the improved default rate and after all of the obligations of the Bond Fund have been satisfied. The Equity Fund bonus may be payable only if (a) Bonds 160 have been paid in full, or sufficient cash has been set aside to pay Bonds 160 in full when due, (b) all obligations under Guarantee 122 have been satisfied or extinguished. The Equity Fund bonus is currently expected to be an amount of cash and/or freely tradable listed securities equal to a certain percentage of the net funds in the Equity Fund after all of the obligations of the Equity Fund have been satisfied.

The first and second alternative structures are not mutually exclusive: many of the features of the two structures may be combined or interchanged.

III. Securities, Insurance Policies, and Payments

Bonds 160 may be issued in the euro markets in a Reg. S/Rule 144A transaction. The repayment of Bonds 160 may be derived first from repayment of QPC Notes 150 to the corresponding Debt Investment Company 110. To the extent a shortfall remains, repayment may be drawn from Guarantee 122, third from the first loss cover provided by Insurance Company 114, and finally through a claim made on the Reinsurance Contract 142.

Debt Investment Company 110 may retain a reserve cash surplus from bond proceeds 104, for example, in an amount equal to 3% of gross proceeds 104, to be credited to the bond segregated account. This retention is for purposes of prudent cash management, with interest income being used to discharge expenses, but the effect is to reduce further the exposure of Insurance Company 114 and reinsurer 140 under policies 124, 142.

The Insurance Policy 124 in respect of the first series of Bonds may be in the amount of 100% of the projected aggregate principal amount of Bonds 160 at maturity. A First Loss Cover in respect of the first series of Bonds may be about 10-30% of the principal amount at maturity, and the Reinsurance Policy 142 may be written in an amount of 70-90% of the Bond principal amount at maturity.

Insurance policy 142 by reinsurer 140 may be structured as negotiated between Insurance Company 114 and reinsurer 140. In some embodiments, Insurance Company 114 may hold the first loss, and reinsurer 140 may only cover a shortfall if companies' payments on both QPC Notes 150 and the proceeds of QPC Warrants 152 are together insufficient to meet bond payment obligations 160. In alternative embodiments, party 140 may serve as a co-insurer, so that Insurance Company 114 and reinsurer 140 share losses on note defaults and warrant gains pro rata. Other facultative and/or proportional co-insurance and/or reinsurance treaty and retrocession arrangements may be agreed upon.

Insurance Company 114 may pay premiums 144 to reinsurer 140. In some embodiments, premiums 144 may include an initial premium, a quarterly premium, a contingent premium, and/or a final premium. The initial premium may be payable on the issue date of Bonds 160, in an amount of about 2% of the maximum accreted principal amount at maturity of Bonds 160. The quarterly premium may be payable after the first anniversary date of policy 142, with each payment being about 0.5% of the risk insured (the difference between the maximum accreted principal amount of the outstanding Bonds 160 less any cash or cash equivalents available to support Bonds 160 in Debt Investment Company 110, Insurance Company 114, Equity Fund 120, and holding company 130). If the parties negotiate for a contingent premium and/or final premium, such premium may be based on surpluses arising in the segregated account, between payments in on QPC Notes 150 and payments out to Bond holders 102. Any contingent and/or final premium may be payable on the stated maturity date of Bonds 160 (or earlier at the option of Insurance Company 114) after payment of trustee and collateral agent fees, management fees, quarterly premium due and payable, and accreted principal amount on Bonds 160, and/or the contingent interest payable on Bonds 160. Any contingent and/or final premium may be calculated based on the net available readily realizable assets of Debt Investment Company 110 at the maturity date with reference to the cash and cash equivalents held by Equity Fund 120 and reflecting the initial and quarterly premium rates.

QPC Notes 150 may be deep-discount zero-coupon obligations. QPC Notes 150 may be issued with an origination discount of about 15% and with an average yield to maturity of approximately 13.5% per annum. QPC Notes 150 may be zero-coupon obligations, level payments of principal and interest, or interest-only payments with a lump-sum terminal repayment of principal. Tenors of QPC Notes 150 may differ based on negotiations with the portfolio companies, with origination discounts ranging from 7.5% to 20% and yield to maturity ranging from 10% to 15% depending on the amount of QPC Warrants 152 received. QPC Notes 150 may be senior or subordinate obligations of the portfolio companies 100, possibly secured by liens on the assets of companies 100. QPC Notes 150 may be the first debt issued by companies 100, they may rank in priority over any other indebtedness or any other equity in operating company 100, and will generally be senior to all equity issued by operating company 100. In other circumstances, they may not be the first debt issued by company 100, and may thus be subordinated to debt of prior lenders. In some arrangements, the coverage backing QPC Notes 150 may increase with each new round of financing, improving the position of Debt Investment Company 110, Insurance Company 114 and reinsurer 140—in contrast to the typical equity investment, in which each new round of investment further subordinates the position of prior investors.

QPC Notes 150 may not require any debt service for a time (three years in one example), only a balloon repayment at maturity. Therefore, operating company 100 may obtain access to capital on terms that avoid near-term pressure on cash flow, during a stage when many companies are short of free cash (available cash is typically conserved to complete product development, to develop manufacturing and distribution facilities and channels, for initial product marketing, and to develop internet strategy). In some alternatives, QPC Notes 150 may come due sooner, for instance, in one year, eighteen months, two years, thirty months, thirty-six months, four years, or five years. In some alternatives, note 150 may be structured to provide no repayment obligation during an initial period, then payments of interest only, or payment of interest and some principal during a second period, and then a final balloon payment.

Repayment of principal and interest on QPC Notes 150 may be tax-deductible to operating company 100, as opposed to dividends on equity that would be taxable distributions. Because of the extended due date of repayment, repayment is deferred until a date when operating company 100 may be more likely to have profits to deduct against.

As part of the arrangement, operating company 100 may also issue an equity security 152 to Debt Investment Company 110. In one alternative embodiment, the equity security may be warrants, rights to purchase additional shares of operating company 100 in the future at a price agreed at the time of issue of the warrants 152. The amount of QPC Warrants 152 issued may be equal to about 2% to 25% (typical values may cluster between 10% to 20%) of the accreted principal amount of QPC Notes 150 at maturity. In one example transaction, operating company 100 may issue QPC Warrants 152 covering an amount of equity in operating company 100 equal to 15% of the cash 154 received by operating company 100. The price per share, and percentage of equity covered by QPC Warrants 152 152, may be agreed among the parties, and may be equal to the share price established in the most-recent (or concurrent) round of equity funding, or alternatively, may be equal to the then-current price of the common stock of operating company 100, or as determined by the operating company's board. In an example transaction, exercise of the QPC Warrants 152 might result in issuing new shares, and Debt Investment Company 110 owing about 4% of the voting stock of operating company 100. The numbers and proportions may vary as agreed among the parties.

Bonds 160 may have a tenor somewhat longer than the tenor of QPC Notes 150, to allow for late repayment by companies 100. For instance, Bonds 160 may have a tenor of 5, 6, 7, 8, 9, 10, 12, 15 or 20 years and be issued at a discount to their principal amount due at maturity. Bonds 160 may have a fixed interest component and/or a contingent interest component. For instance, the fixed interest component may be based on current market rates for bonds of similar rating, or be just in excess of inflation, or may be essentially equal to the zero-risk rate of return for treasury bonds. The contingent interest component may be between 3% and 10% per annum, or a single payment of 3% to 8% of the accreted principal amount of Bonds 160 payable on the maturity date of Bonds 160 (or date of earlier redemption). In some alternatives, Bonds 160 may bear a floating interest rate. There may be a floating rate contingent interest component that may depend on the performance of the Debt Investment Company's investments in portfolio companies 100, or on the rating assigned to Bonds 160. The contingent interest component may be contingent on the available excess cash in Debt Investment Company 110. The contingent interest may not be reinsured. Payment of contingent interest may be contingent upon the existence and availability of cash and cash equivalents in Debt Investment Company 110, including cash available through Equity Fund 120 and insurance 114. Debt Investment Company 1104 may issue Bonds 160 to Bondholders 102 102; Bonds 160 may be listed on a trading exchange. Bonds 160 may be rated by a rating agency such as Moody's or Standard & Poor's. Because of the diversification of risk and insured payment, Bonds 160 may carry a rating of A, AA+or higher or lower, depending on the rating of Insurance Company 114 and/or reinsurer 140 or other factors.

Bonds 160 and QPC Notes 150 may be structured to reduce the risk of a claim under the insurance policy 142. Debt Investment Company 110 may not be required to make any payments on Bonds 160 prior to the anticipated maturity date. In contrast, QPC Notes 150 may be repayable three years from issuance. In addition, Bonds 160 may have the benefit of the insurance policy from Equity Fund 120 as discussed above. Additional cover may be provided by liquidity events (typically an IPO, sale or merger of operating company 100) with respect to QPC Warrants 152. Based on industry averages for the last five years, such liquidity events are expected to occur between two and three years after the issuance of a particular note 150. The bondholders 102 may have no right to require Debt Investment Company 110 to repurchase Bonds 160 before their maturity (absent an event of default on Bonds 160).

IV. Example

Consider one example investment in one operating company 100, where the net investment capital 154 received by the operating company 100 is $ 5 million. The origination discount on note 150 may be a fee of 15%, either as a mark-up or as a discount. In an embodiment using a 15% mark-up, immediately after receiving proceeds 154, operating company 100 would be obligated to repay $ 5 million plus 15%, or $ 5,750,000. In this example, note 150 of $ 5,750,000 compounded at 13% over three years to maturity will be repayable at $ 8.293 million.

Over the course of the arrangement, Insurance Company 114 may be paid about 2% per year—over a five-year period, the guaranteed premium may be about 10%. As a bonus premium, Insurance Company 114 may contract for a participation in any surplus realized by Debt Investment Company 110 and Equity Fund 120. Thus, the insurance premium may total about 15-18% of the total value of the risk written.

Through its relationship with Originating Company 134, Debt Investment Company 110 may benefit from relationships with partner VC's. These relationships may provide first and best choice deals 220 for Debt Investment Company 110. These relationships may also provide incentives for the concurrently-investing partner VC to monitor and review the investment. VC may be a participant in an initial step only and then drop out of the transaction while negotiation is initiated with portfolio company 100.

The management of Debt Investment Company 110 and Insurance Company 114 may receive financial incentives for out-performing model assumptions.

V. Process Flow and Cash Flow

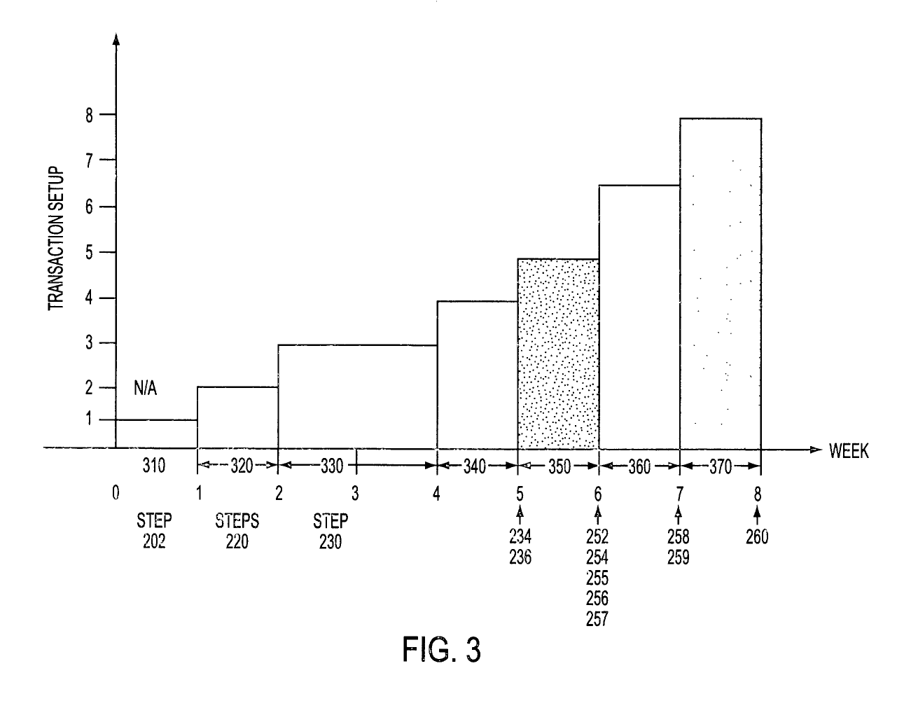

FIG. 2 shows the decision-making process, process flow, and flow of cash 200 by which an investment arrangement is formed, typically over the course of a few weeks. (As will be discussed in more depth in connection with FIG. 3, the flows on FIG. 2 relate to a single deal. FIGS. 3-5 will expand this focus to the pooling of multiple deals.) In the first part of the cycle (step 202), portfolio company 100 reaches agreement on a deal term sheet with a VC firm 210. In the term sheet, operating company 100 and VC 210 agree on how much cash VC 210 will contribute to operating company 100, how much proposed debt in that operating company 100 that Debt Investment Company 110 will contribute, and how much equity will be posted. VC 210 may introduce operating company 100 to Originating Company 132, 134.

In some cases, operating company 100 may be introduced to Originating Company 132, 134 by VC 210. In other cases, VC 210 may act as intermediary between operating company 100 and Originating Company 132, 134.

In step 220, operating company 100 supplies Originating Company 132, 134 with supporting documentation to obtain approval of Originating Company 132, 134. Originating Company 132, 134 may reject the deal (step 222) and send it back to portfolio operating company 100. On the other hand, if the deal is interesting to Originating Company 132, 134, Originating Company 132, 134 will then provisionally accept the deal (step 224).

In step 226, Originating Company 132, 134 undertakes a process of due diligence of operating company 100, to confirm the projections with respect to operating company 100. Originating Company 132, 134 will be aware of the underwriting standards of Debt Investment Company 110 and Insurance Company 114, and will seek to negotiate a deal conforming to those standards. Originating Company 132, 134 may also have the deal reviewed by external experts, such as accountants or others (step 228).

In a first alternative, after the due diligence of step 226 is complete, Originating Company 132, 134 will present the deal to Debt Investment Company 110 and/or Insurance Company 114. Debt Investment Company 110 and/or Insurance Company 114 may review the deal using an independent investment/credit committee, and may negotiate terms on which Debt Investment Company 110 may buy QPC Notes 150 and QPC Warrants 152.

In a second alternative, after the due diligence of step 226 is complete, Originating Company 132, 134 will take the deal to its own credit committee who will make a decision (step 230). If the credit decision is to reject (step 232) (e.g., based on external review, or conditions not satisfied), the papers will be sent back to operating company 100. If the originator's credit committee approves the deal (step 234), Originating Company 132, 134 will prepare to commit funds for that deal, and present the deal (step 236) to Debt Investment Company 110 and/or Insurance Company 114. In some embodiments, the acceptance 234 by Originating Company 132, 134 may be only a provisional acceptance, subject to approval by Debt Investment Company 110 and/or Insurance Company 114. Originating Company 132, 134 may negotiate terms on which Debt Investment Company 110 may buy QPC Notes 150. Debt Investment Company 110 and/or Insurance Company 114 may review the deal using an independent investment/credit committee, e.g., based in Bermuda and London. Providing two separate credit approvals (one for Originating Company 132, 136 and a separate credit approval for Debt Investment Company 110) provides tax advantages under United States law. If Debt Investment Company 110 rejects the deal (step 242), the deal goes back to Originating Company 132, 134, who in turn returns the deal (step 244) back to VC 210. In some embodiments, for instance, those where U.S. tax law does not apply, steps 236, 240, 242, 244 may be omitted—after approval in step 234, the transaction may proceed directly to step 250.

Under either the first or second alternative, step 240 may begin after a deal is closed between operating company 100 and Originating Company 132, 134. In an alternative, step 240 may proceed in parallel with the negotiations between operating company 100, VC 210, and Originating Company 132, 134

The deal may be approved (step 250) by Debt Investment Company's credit review 240 where the decision may be communicated to Originating Company 132, 134 and to the portfolio operating company 100 (step 252). In step 254, portfolio operating company 100 may issue shares to VC 210 in return for cash 255. The shares issued in step 254 may be voting stock, and/or may be preferred voting stock.

In one alternative, Debt Investment Company 110 buys QPC Notes 150 and QPC Warrants 152 from operating company 100.

In a second alternative, in step 256 (possibly simultaneously with 254) operating company 100 issues QPC Notes 150 and QPC Warrants 152 to Originating Company 132, 134, and Originating Company 134 pays cash payment 154. Originating Company 134 may borrow (step 257) from a bank to buy QPC Notes 150 and QPC Warrants 152, and may carry them onto its own books for its own accounts. It therefore has originated the purchase of QPC Notes 150 and QPC Warrants 152. In step 258, approximately five days after step 236, Debt Investment Company 110 buys QPC Notes 150 and QPC Warrants 152 from Originating Company 132, 134, for cash payment 136, and Originating Company 134 repays its bank loan 259. In step 260, Debt Investment Company 110 contributes QPC Warrants 152 to Equity Fund 120 or transfers QPC Warrants 152 as a dividend or a distribution in specie to holding company 130, which in turn transfers them as a capital contribution to Equity Fund 120. Alternatively, Debt Investment Company 110 may transfer or sell QPC Warrants 152 to Equity Fund 120 in return for Equity Fund guarantees. Alternatively, Originating Company 132, 134 may sell QPC Warrants 152 directly to Equity Fund 120, and QPC Notes 150 directly to Debt Investment Company 110.

VI. Negotiations

The steps shown in FIG. 2 may proceed on the timeline shown in FIG. 3. The horizontal axis shows time measured in weeks, from zero to eight weeks. The vertical axis shows the steps in the transaction.

In the first week 310, VC is arranging its deal with operating company 100, and neither Bondholders 102, Debt Investment Company 110, Insurance Company 114, Negotiating Company 132 nor Originating Company 134 are directly involved (though they may well consult in order to facilitate later steps in the transaction, for instance to advise on terms that would likely be acceptable to other parties).

Second week 320 includes steps 220-222, discussions between Negotiating Company 132 and portfolio operating company 100. Due diligence by Negotiating Company 132 begins in second week 320 and may continue through weeks three and four 330. During week four, the deal is under evaluation by a transaction manager of Negotiating Company 132, and during week five 340, by executives of Negotiating Company 132.

By the end of week five, Negotiating Company 132 prepares a package and passes the deal over to Debt Investment Company 110 and/or Insurance Company 114 for approval (steps 234, 236). During week six 350, the credit review committee or board of directors of Debt Investment Company 110 and/or Insurance Company 114 review the deal. If the deal is approved, during week seven 360, Originating Company 134 buys the QPC Notes 150 and QPC Warrants 152 from operating company 100 (steps 254, 255, 256, 257). At the end of week eight 370, the QPC Warrants 152 pass from Debt Investment Company 110 to Equity Fund 120.

In another alternative, during week five, Negotiating Company 132 submits the deal to Debt Investment Company 110 and/or Insurance Company 114 for approval. Concurrently, Originating Company 134 buys the QPC Notes 150 and QPC Warrants 152 from operating company 100. In this embodiment, Debt Investment Company 110 may refuse to purchase securities 150, 152 from Originating Company 132, 134, and Originating Company 132, 134 may be left with the risk of finding alternative financing.

In still another alternative, after operating company 100 and VC 210 agree on a term sheet, VC 210 may present the deal to Capital Company 182. Capital Company 182 may perform its due diligence, typically during weeks three and four. One approval, operating company 100 may issue QPC Notes 150 and QPC Warrants 152 to Capital Company 182. Typically during week six, Capital Company 182 may recommend the deal to Debt Investment Company 110. Debt Investment Company 110 may conduct its own diligence, typically during week seven. On approval, QPC Warrants 152 may be transferred to Equity Fund 120.

VII. Transfer and Grant of Assets and Interests in Assets at Closing

A. Originating Company to Debt Investment Company

By the time of the closing of the transaction (the “Closing”), it is expected that Originating Company 132, 134 may have acquired a certain amount of QPC Notes 150 and QPC Warrants 152 to be offered for sale to Debt Investment Company 110.

At Closing, Originating Company 132, 134 may sell the initial pool of QPC Notes 150 and QPC Warrants 152 to Debt Investment Company 110 for a purchase price in an amount described below in section VIII.

B. Debt Investment Company to Equity Fund and Special Purpose Vehicle

At Closing, Debt Investment Company 110 may contribute QPC Warrants 152 to Equity Fund 120 in exchange for Guarantee 122 and all of the equity of Equity Fund 120. After the payment in full of Bonds 160, any gains resulting from any increase in the value of the equity of Equity Fund 120 may accrue to the benefit of the holder of such equity, which is Debt Investment Company 110. Debt Investment Company 110 may issue to the shareholders 178 of Group Holding Company 180 and possibly the provider of the first loss cover options to acquire the stock of Equity Fund 120. Subject to its terms, Guarantee 122 may guarantee the repayment of Bonds 160 to the extent there is any shortfall from amounts derived from QPC Notes 150.

Concurrently, Debt Investment Company 110 may sell QPC Notes 150 and Guarantee 122 to Special Purpose Vehicle 116 in a “true sale” transaction for a purchase price in an amount described below section VIII.

C. Special Purpose Vehicle to Indenture Trustee

At Closing, Special Purpose Vehicle 116 may grant first priority perfected security interests in and to QPC Notes 150 and assign the benefit of Guarantee 122 to the indenture trustee or a collateral agent for the benefit of the insurer, other service providers (e.g., the trustee and Manager), any hedge counterparty and bondholders 102. Special Purpose Vehicle 116 may also pledge its rights under certain agreements, such as the insurance agreement and any hedge agreements, to the trustee or a collateral agent for the benefit of such secured parties.

However, proceeds and collections on or in respect of QPC Notes 150 and Guarantee 122 may be applied to payments in the order of priority set forth in the waterfall section of the indenture.

VIII. Purchase Price of Assets Transferred at Closing

The net proceeds (i.e. the issuance proceeds 104 net of various costs and expenses such as insurance premiums and closing costs, etc.) of the offering of Bonds 160 at Closing may represent the value of QPC Notes 150 and Guarantee 122 in cases where the total initial pool of QPC Notes 150 has been originated and was being transferred to Special Purpose Vehicle 116 at Closing.

In cases where the total initial pool of QPC Notes 150 and QPC Warrants 152 may not have been originated by Closing, a portion of the net proceeds from the issuance of Bonds 160 at Closing may be set aside for future purposes. In such cases, the net proceeds of Bond offering 160 may be allocated between QPC Notes 150 and QPC Warrants 152 acquired prior to the Closing and those to be acquired post-Closing. Net proceeds allocated to QPC Notes 150 and the rights under Guarantee 122 to be acquired at Closing (the “Initial Purchase Price”) may be paid by Special Purpose Vehicle 116 to Debt Investment Company 110 to pay for the initial QPC Notes 150 and Guarantee 122. This purchase price that Special Purpose Vehicle 116 may pay Debt Investment Company 110 at Closing to acquire QPC Notes 150 and Guarantee 122 may be equal to (i) the price paid by Debt Investment Company 110 to Originating Company 132, 134 to acquire QPC Notes 150 and QPC Warrants 152 relating to Guarantee 122, which price may be approximately equal to the price Originating Company 132, 134 paid in acquiring such QPC Notes 150 and QPC Warrants 152 plus an appropriate profit for Originating Company 132, 134 plus (ii) a small amount to cover ongoing expenses of Debt Investment Company 110 related to the investment committee and other items. The remaining funds from the issuance of Bonds 160 may be deposited into a controlled account and invested in eligible investments (e.g., money market securities) pending the post-Closing purchase of additional QPC Notes 150.

Debt Investment Company 110 may apply the Initial Purchase Price to pay Debt Investment Company's Purchase Price to Originating Company 132, 134 for the initial QPC Notes 150 and QPC Warrants 152.

IX. Transfer of Assets and Interests in Assets Post-Closing

A. Flow Purchase Agreements

At Closing, Debt Investment Company 110 and Originating Company 132, 134 may enter into a flow purchase agreement pursuant to which Debt Investment Company 110 may, but will generally not be obligated to, purchase QPC Notes 150 and related QPC Warrants 152 from time to time at an arms length price likely to be approximately equal to the price Originating Company 132, 134 paid to acquire such QPC Notes 150 and QPC Warrants 152 plus an appropriate profit. Debt Investment Company 110 may not be obligated to purchase QPC Notes 150 and QPC Warrants 152 from Originating Company 132, 134 and will generally not purchase any of the same without approval of its Investment Committee. Furthermore, Originating Company 132, 134 will generally have closed the purchase of QPC Notes 150 and QPC Warrants 152 prior to the final decision by Debt Investment Company 110 to purchase QPC Notes 150 and QPC Warrants 152 from Originating Company 132, 134.

Also at Closing, Debt Investment Company 110 and Special Purpose Vehicle 116 may enter into a flow purchase agreement pursuant to which Special Purpose Vehicle 116 may agree to purchase and Debt Investment Company 110 may agree to sell from time to time all QPC Notes 150 (and the pledge of the related QPC Warrants 152 to further secure Guarantee 122) that Debt Investment Company 110 acquires from Originating Company 132, 134 for a price equal to the price paid by Debt Investment Company 110 to Originating Company 132, 134 for such QPC Notes 150 and the related QPC Warrants 152 plus a small amount to cover Debt Investment Company's ongoing expenses related to the investment committee and other items.

On a post-closing purchase date, Special Purpose Vehicle 116 may withdraw from the account in which uninvested proceeds are held an amount equal to the price of the related QPC Notes 150 and their related QPC Warrants 152 (which price may be equal to the amount paid by Debt Investment Company 110 to Originating Company 132, 134 to acquire such QPC Notes 150 and related QPC Warrants 152) and may pay such amount to Debt Investment Company 110 in exchange for QPC Notes 150 (and the pledge of the related QPC Warrants 152 to further secure Guarantee 122). Concurrently, Debt Investment Company 110 may apply such amount to pay for QPC Notes 150 and QPC Warrants 152 from Originating Company 132, 134, and may contribute or otherwise transfer QPC Warrants 152 to Equity Fund 120 which may pledge the same as security for Guarantee 122. The Special Purpose Vehicle 116 may pledge QPC Notes 150 to the indenture trustee or the collateral agent and may take all steps necessary to assure that such transferee had a first priority, perfected security interest in such QPC Notes 150 for the benefit of the insurer, other service providers (e.g., the trustee and Manager), any hedge counterparty and bondholders 102.

X. Pooling Transactions to form a Portfolio

To form a portfolio of securities to back Bonds 160, the transaction of FIGS. 2 and 3 is repeated for a portfolio of companies. The size of a fund may vary, with $ 100 million to $ 1 billion, with $ 250 million to $ 500 million being preferred. The portfolio may include any reasonable number of companies 100, from two to three hundred, with the actual number depending on the total amount 104 raised in Bonds 160 and the amount of investment 154 made in each operating company 100. Typically between one hundred to two hundred companies revolve through the portfolio over the life of a fund (determined by tenor of bonds). The amount of each investment may range from $ 1 million to $ 50 million, with $ 3 million to $ 12 million being preferable, and $ 4 million to $ 7 million being more preferable still. Investments 154 to operating companies 100 may average about $ 4 million to $ 5 million. Each operating company 100 may move through the process at a different rate, and the companies' progress may be somewhat staggered from each other. A portfolio may be opened with the receipt of investments 104, and the deals with companies 100 will be initiated over the next several months.

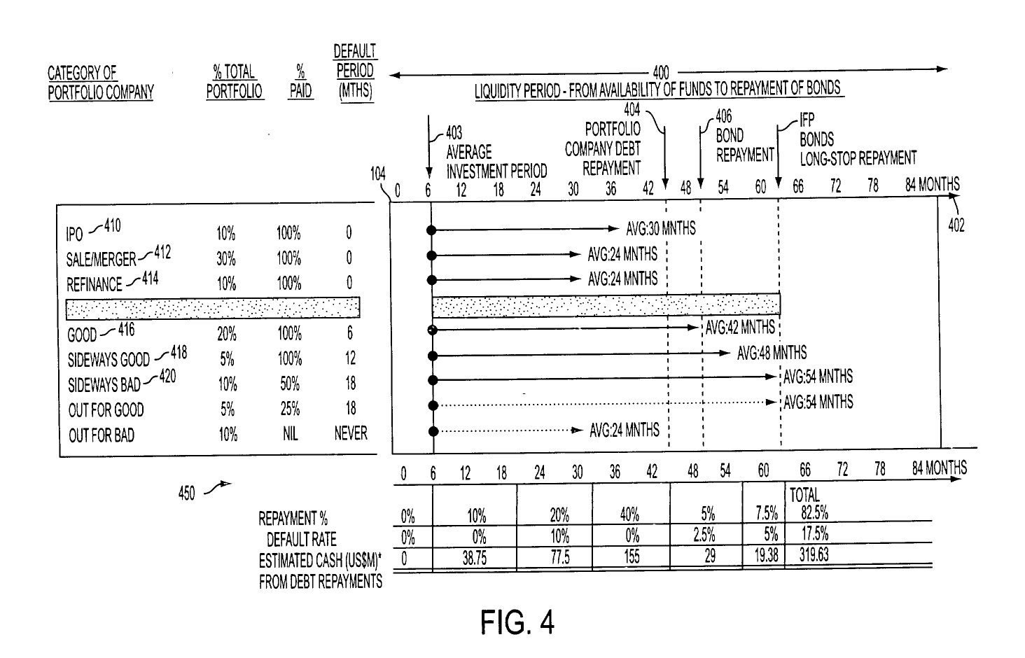

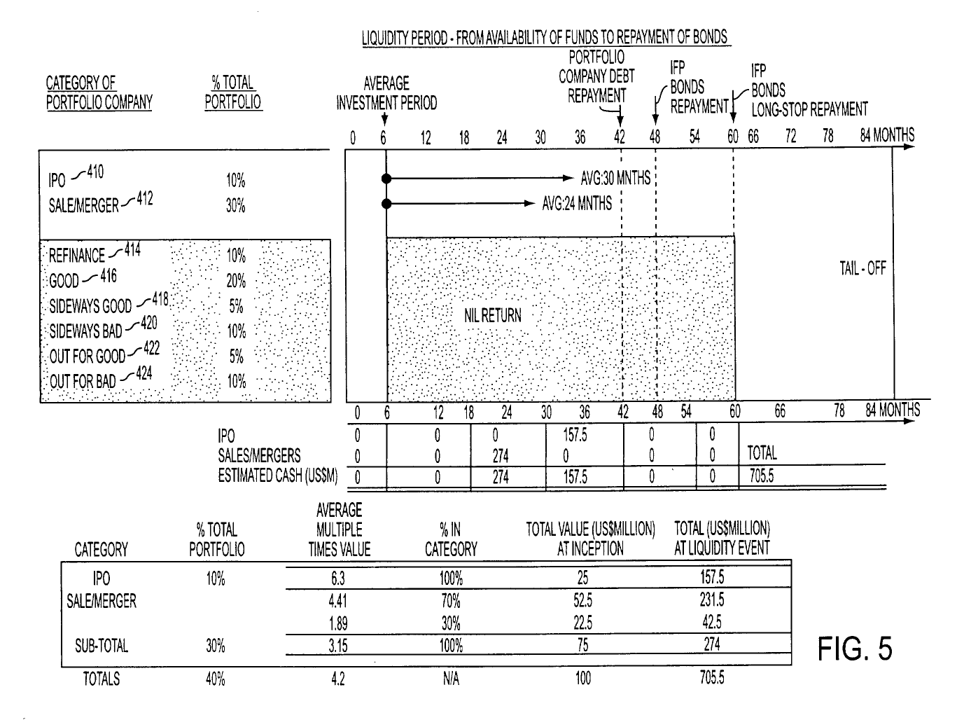

Referring to FIGS. 4 and 5, Insurance Company 114 and reinsurer 140 will evaluate two primary risk factors to assess the likelihood of Insurance Company 114 or reinsurer 140 paying on insurance policies 124, 142. (i) What is the projected rate of repayment on QPC Notes 150, to make cash available before the repayment date for Bonds 160? (ii) What is the likely cover, the projected ratio of the value of the repayment on QPC Notes 150 plus the value of QPC Warrants 152, relative to the exposure under insurance policies 124, 142?

FIG. 4 shows the funds available to repay Bonds 160 at the five-year maturity date of Bonds 160. The horizontal axis 402 measures time, from zero to eighty-four months.

The vertical axis of FIG. 4 shows a representative mix of the portfolio companies 100, and what is likely to happen to the portfolio operating company 100 during investment period 400.

In the example of FIG. 4, the portfolio has eight classes 410-424 of companies. Consider a example estimate of the prospects of the companies 100 in the category mix and what would 115 happen over the sixty-month life of Bonds 160.

In this example, it is assumed that the average deal with an operating company 100 is closed (steps 252-259 of FIG. 2) about six months 403 into investment period 400. This delay reflects the time after the date of initial investment 104 required to identify the companies with which negotiations will be pursued, as well as the negotiations shown in FIG. 2—the portfolio of companies 100 will be assembled over some months. In the example of FIG. 4, the tenor of QPC Notes 150 is thirty-six months—combined with the six month initial lag time 403, payment of QPC Notes 150 occurs starting at about forty-two months into investment period 400. The proceeds from repayment 404 is used to retire Bonds 160 over a period 406 extending from about fifty to sixty months.

Class one 410 of the portfolio companies are those that will have an initial public offering (IPO). On the assumptions of FIG. 4, class one 410 will include about 15% of the portfolio mix, and repay its QPC Notes 150 after thirty months. Added to the average six month investment lag 403, the companies of class one 410 will have repaid their QPC Notes 150 after thirty-six months after issuance of Bonds 160.

Class two 412, 25% of all companies 100, will either be sold or merge with another company; FIG. 4 projects sale or merger to occur on average after twenty-four months, thirty months into the life of bond 160. Companies of class three 414, 10%, will refinance themselves through either a new investment in or through other forms of financing, and pay off QPC Notes 150 through that refinancing. Class four 416, 20% of companies 100, are reasonably good companies with cash flow but not extraordinary profits—good enough to repay their QPC Notes 150 on time. Class five 418, 5%, can be called “sideways good”—good enough to repay QPC Notes 150, but twelve months late in doing so. Some of these companies 412, 414, 416, 418 may pay their QPC Notes 150 six months late, at forty-eight months into investment period 400. Even with such delays, cash is received by Debt Investment Company 110 well before repayment of Bonds 160 comes due at sixty months.

Class six 420, about 10% of companies, can be called “sideways bad”—these companies are breaking even, but struggling to pay QPC Notes 150 and to refinance. “Sideways bad” companies will repay half their QPC Notes 150 eighteen months late, and the other half of QPC Notes 150 will be lost. Class seven 422, about 5%, can be called “out for good” operating company 100 fails, but the residual assets can be sold for a 25% recovery, eighteen months late. Class eight 424, about 10%, can be called “out for bad,” with zero repayment. The prospects of repayment from these companies 420, 422, 424 would be ascertainable forty-eight months from the date of note 150, six months before the repayment date for Bonds 160.

The financial model assumes a default rate by portfolio companies 100 of 15%. This default rate may be compared to an industry average failure rate (over the last five years) of 12% for expansion stage companies as calculated based on statistics in Venture Economics. Many potential partner VC's 210 are reporting failure rates of less than 5%. Failure rates do not necessarily equate to default rates because a portfolio company 100 that fails may repay all or a portion of its note 150. Therefore, under these assumptions, the projected default rate of 15% is expected to be a conservative estimate Lower portion 450 of FIG. 4 uses the same horizontal axis, months since investment 104, to track cumulative repayments over investment period.

Referring to FIG. 5, even in a rather negative scenario, reinsurer 140 will have negligible risk of paying a claim on insurance policy 142. Consider the case where the 60% of companies in classes three 414 (refinance), four 416 (repay on time), five 418 (sideways good—repay twelve months late), six 420 (“sideways bad”—half repayment eighteen months late), seven 422 (“out for good”—25% recovery), and eight 424 (“out for bad,” with zero repayment) all fail completely, with zero repayment. The assumption for class one 410 is that 15% of the companies will IPO, typically after thirty months, with an average equity multiple at IPO of 6.3. The assumption for class two 412 is that 25% of companies will be sold or merge with other companies, typically after twenty-four months, with an average equity multiple at IPO of 3.15. In the example of FIG. 5, the initial investment 104 is $ 250 million.

XI. Risks to Insurer

Debt Investment Company 110 and Insurance Company 114 may seek to obtain a combination of QPC Notes 150 and QPC Warrants 152 150 from companies 100 at the time of the purchase of QPC Notes 150 so that the asset cover (net assets of a portfolio company 100, including investment from QPC Notes 150 and QPC Warrants 152, after adjusting asset valuations for actual residual values attributable to an operating company's assets on an open market forced sale or liquidation basis as determined by an independent recognized valuation) will be least 200% of the accreted principal amount of the note 150 at maturity.

At the time of the purchase of QPC Notes 150 by Debt Investment Company 110, the equity cover (the total equity in issued and paid up share capital in the portfolio company 100 at the date of issue of the note 150, as of the date of issue of QPC Notes 150, divided by the principal amount of the note 150) in a portfolio company may be about 300%. The average equity cover across Debt Investment Company 110's portfolio of QPC Notes 150 is expected to be approximately 400%. Because of the subsequent rounds of equity financing that would normally take place for an expansion stage company over the course of investment period 400, equity cover may rise to near 1000% by the time of the repayment of note 150.

QPC Notes 150 may provide approximately 113% cash cover for the accreted principal amount of Bonds 160 after five years. “Cash Cover” means the amount of cash and cash equivalents of Debt Investment Company 110 prior to maturity of Bonds 160 and available to repay Bonds 160. In addition, Debt Investment Company 110 may have the benefit of the pledge from Equity Fund 120. Projected cash flow generated by liquidity events with respect to QPC Warrants 152 may extend the total cash cover to over 175% at maturity.

Principal and interest payment on QPC Notes 150 alone may return sufficient cash to cover payments on Bonds 160 to enable the insurer to come 100% off cover as to insurance policy 142 (assuming no first loss cover included in insurance policy 142) approximately fifty-four months after the issue of Bonds 160. The cash flow from QPC Warrants 152 alone may enable the insurer's risk to come 50% off cover as to insurance policy 142 (assuming no first loss cover included in insurance policy 142) thirty months after the issue of Bonds 160. The combined cash flow from QPC Notes 150 and QPC Warrants 152 is projected to cause the insurer to come 100% off cover between twenty-four and thirty-six months after the issuance of Bonds 160.

Throughout this disclosure, numerical values are given as examples or approximations only. The exact values will vary arrangement to arrangement, and may be negotiated among the parties based on the facts of a particular deal. The numbers may also tend up or down based on experience. For instance, insurance premiums of 2% and 0.5% may be higher if it is found that the risks are greater, and may be negotiated down if the parties conclude that the risks are reduced. Origination discounts and yields may vary depending on the competitive sources of funding available to VC's and companies 100. Asset cover, equity cover, and cash cover may vary with each deal, and may be subject to contractual minimums negotiated between Insurance Company 114 and reinsurers 140. Terms may also vary with market and economic conditions.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

We claim:

1. A method, comprising the steps of:
receiving funds from a plurality of capital markets investors into an investment company unaffiliated with the investors, the investors receiving in return a debt claim against the investment company;
investing a substantial majority of the invested funds from the investment company directly into operating companies as debt obligations of the operating companies for essentially unrestricted use by the operating companies, the terms providing at least one year of relief from repayment of the debt, the investment company receiving a security interest in substantially all assets of the operating companies.
out of the invested funds, purchasing an insurance policy for the benefit of the investor, the insurance policy covering the investment company against default by the operating companies and insuring repayment to the investor of the funds invested, the insurer of the insurance policy receiving benefit of debt and equity interests in the operating companies.

2. A method, comprising the steps of:
receiving funds from a capital markets investor into an investment company;
investing a substantial majority of the invested funds from the investment company into one or more operating companies;
arranging an insurance policy for the benefit of the investor, the insurance policy insuring repayment to the investor of the funds invested, the insurer of the insurance policy receiving benefit of debt and equity interests in the operating company or companies.

3. The method of claim 2, wherein:
the investment company receives investments from a plurality of investors.

4. The method of claim 3, wherein:
the investment company's investment in the operating company is on terms not requiring principal repayment by the operating company to the investment company for at least one year, a repayment obligation of the operating company to the investment company being supported by an equity interest in the operating company.

5. The method of claim 3, wherein:
the insurance policy covers the investment company against default by the operating company and insures payment of principal and interest to the investors.

6. The method of claim 3, further comprising the step of:
investing a substantial majority of the invested funds from the investment company out to one or more operating companies for business expansion of the operating companies, the investment company receiving a security interest in substantially all assets of the operating companies.

7. The method of claim 2, wherein the debt claim received by the investor is an indirect claim, co-mingled with debt claims against other operating companies

8. The method of claim 2, wherein the insurance policy insures payment of interest arising under the debt claim.

9. The method of claim 2, wherein the investment company raises its capital in the capital markets.

10. The method of claim 2, wherein the investor receives no equity in the investment company.

11. The method of claim 2, wherein an agreement between the investor and the investment company contemplates repayment of the funds within seven years.

12. The method of claim 2, wherein the investment company receives an equity interest in the operating company in return for its investment.

13. The method of claim 12, wherein the equity interest received by the investment company includes a warrant exercisable for stock of the operating company.

14. The method of claim 2, wherein the investment company receives a debt interest in the operating company in return for its investment.

15. The method of claim 14, wherein the debt issued by the operating company provides for repayment forbearance for at least one year.

16. The method of claim 14, wherein the operating company receives unrestricted use of funds invested by the investment company.

17. A method, comprising the steps of:
receiving funds from a capital markets investor into an investment company;
investing a substantial majority of the invested funds from the investment company into an operating company as a debt obligation of the operating company, the terms providing at least one year of relief from repayment of the debt.

18. The method of claim 17, further comprising the step of:
investing a substantial majority of the invested funds from the investment company out to a plurality of operating companies on terms not requiring principal repayment by the operating companies to the investment company for at least one year, repayment obligation of the operating companies to the investment company being supported by an equity interest in the operating companies.

19. The method of claim 18, further comprising the step of:
out of the bond proceeds, purchasing an insurance policy covering the investment company against default by the operating companies and insuring payment of principal and interest to the investors.

20. The method of claim 19, wherein the insurance policy insures payment of interest arising under the debt claim.

21. The method of claim 18, further comprising the step of:
the investment company receiving a security interest in substantially all assets of the operating companies.

22. The method of claim 18, wherein the bonds are sold to unaffiliated investors in the capital markets.

23. The method of claim 17, wherein the investor receives an indirect debt claim against the operating company, co-mingled with debt claims against other operating companies

24. The method of claim 17, wherein the investment company raises its capital in the capital markets.

25. The method of claim 17, wherein the investor receives no equity in the investment company.

26. The method of claim 17, wherein the investment company receives an equity interest in the operating company in return for its investment.

27. The method of claim 26, wherein the equity interest received by the investment company includes a warrant exercisable for common stock of the operating company.

28. The method of claim 17, wherein the investment company receives a debt interest in the operating company in return for its investment.

29. The method of claim 28, wherein the debt issued by the operating company provides for repayment forbearance for at least one year.

30. The method of claim 28, wherein the operating company receives unrestricted use of funds invested by the investment company.

31. The method of claim 17, wherein the investment company includes a number of separate entities chartered in several distinct jurisdictions.

32. The method of claim 31, wherein the investment company includes a special purpose vehicle chartered to hold the assets and liabilities of a single series of finds received from capital markets investors.

33. A method, comprising the steps of:
receiving funds from a plurality of capital markets investors into an investment company;
investing a substantial majority of the invested funds from the investment company directly to an operating company for business expansion of the operating company, the investment company receiving a security interest in substantially all assets of the operating company;
out of the invested funds, purchasing an insurance policy covering the investment company against default by the operating company and insuring repayment of principal to the investors.

34. The method of claim 33:
wherein the plurality of investors receive debt claims against the investment company in return for their invested funds.

35. The method of claim 33, wherein:
the insurance policy insures payment of principal and interest to the investors.

36. The method of claim 33, wherein the debt claim received by the investor is an indirect claim, co-mingled with debt claims against other operating companies

37. The method of claim 33, wherein the investor receives no equity in the investment company.

38. The method of claim 33, wherein an agreement between the investor and the investment company contemplates repayment of the funds within seven years.

39. The method of claim 33, wherein the investment company receives an equity interest in the operating company in return for its investment.

40. The method of claim 39, wherein the equity interest received by the investment company includes a warrant exercisable for stock of the operating company.

41. The method of claim 33, wherein the investment company receives a debt interest in the operating company in return for its investment.

42. The method of claim 41, wherein the debt issued by the operating company provides for repayment forbearance for at least one year.

43. The method of claim 33, wherein the operating company receives unrestricted use of funds invested by the investment company.

44. The method of claim 33, further comprising the step of:
investing the funds to a plurality of operating companies, the investment company receiving a security interest in assets of each operating company of the plurality.

45. The method of claim 33, wherein the investment company further receives a security interest in all available assets of the operating company.

46. The method of claim 33, wherein the investment company further receives a fixed yield return on the money lent to the operating company.

47. The method of claim 33, wherein the investment company further receives an equity interest in the operating company.

48. A method, comprising the steps of:
receiving funds from a plurality of capital markets investors into an investment company unaffiliated with the investors;
investing a substantial majority of the invested funds from the investment company out to one or more operating companies for essentially unrestricted use by the operating companies, the investment company receiving a security interest in substantially all assets of the operating companies.

49. The method of claim 48:
wherein the plurality of investors receive debt claims against the investment company in return for their invested funds.

50. The method of claim 50, further comprising the step of:
arranging an insurance policy for the benefit of the investors, the insurance policy insuring repayment to the investor of the funds invested, the insurer of the insurance policy receiving benefit of debt and equity interests in an operating company.

51. The method of claim 50, wherein:
the insurance policy insures payment of principal and interest to the investors.

52. The method of claim 48, wherein the debt claim received by the investor is an indirect claim, co-mingled with debt claims against other operating companies

53. The method of claim 48, wherein the investor receives no equity in the investment company.

54. The method of claim 48, wherein the investment company receives an equity interest in the operating company in return for its investment.

55. The method of claim 54, wherein the equity interest received by the investment company includes a warrant exercisable for stock of the operating company.

56. The method of claim 48, wherein the investment company receives a debt interest in the operating company in return for its investment.

57. The method of claim 56, wherein the debt issued by the operating company provides for repayment forbearance for at least one year.

58. A method, comprising the steps of:
receiving funds from capital markets investors into an unaffiliated investment company, the investors receiving in return a debt claim against the investment company, the debt claim covered by an insurance policy insuring payment of principal and interest;
investing a substantial majority of the invested funds from the investment company out to one or more operating companies.

59. The method of claim 58, wherein:
an insurer of the insurance policy receives benefit of debt and equity interests in the operating company.

60. The method of claim 58, wherein:
the terms of the investing to the operating companies providing at least one year of relief from repayment of the debt.

61. The method of claim 58, wherein the insurance policy insures payment of interest arising under the debt claim.

62. The method of claim 58, wherein the investor receives no equity in the investment company.

63. The method of claim 58, wherein the investment company receives an equity interest in the operating company in return for its investment.

64. The method of claim 63, wherein the equity interest received by the investment company includes a warrant exercisable for stock of the operating company.

65. The method of claim 58, wherein the investment company receives a debt interest in the operating company in return for its investment.

66. The method of claim 65, wherein the debt issued by the operating company provides for repayment forbearance for at least one year.

67. The method of claim 65, wherein the operating company receives unrestricted use of funds invested by the investment company.
